(19) United States
(12) Patent Application Publication
(10) Pub. No.: US 2005/0263667 A1
(43) Pub. Date: Dec. 1, 2005

(54) Motorcycle flag holder mountable on rear axle nut

(76) Inventors: Kevin Boyd Fisher, Elk Ridge, UT (US); Preston Kurt Fisher, Lindon, UT (US)

Correspondence Address: Angus C. Fox, III, 4093 N. Imperial Way, Provo, UT, 84604-5386, US

(21) Appl. No.: 10/856,576

(22) Filed: May 28, 2004

(51) Int. Cl. H01Q 1/12

(52) U.S. Cl. 248/534

(57) ABSTRACT

A motorcycle flag holder mountable on a rear axle nut includes a main body formed from plate stock having spaced-apart first and second major planar surfaces. The main body has a regular-duodecagonally-shaped nut-securing aperture with a central an axis perpendicular to the major planar surfaces. The nut-securing aperture is sized to slide over the axle nut. The main body incorporates a slit that begins at an outer edge of the main body and terminates at an edge of the nut-securing aperture. First and second opposing portions of the main body on either side of the slit can be drawn together with a nut-securing bolt, thereby causing the nut-securing aperture shrinks in size and tighten around the axle nut. The main body also includes a flag staff retaining bore in which a flag staff may be secured with a thumb screw.

### BACKGROUND OF THE INVENTION

1. Field of the Invention

This invention relates to holders for flags, pennants, logos and indicia and, more particularly, to flag holders mountable on all-terrain vehicles and motorcycles.

2. Description of the Prior Art

Safety flags are typically required to be mounted on motorcycles and all-terrain vehicles when used off-road on government property. The safety flags announce the position of the vehicle before the vehicle or rider is visible when climbing a berm. Such a flag holder is disclosed in U.S. Pat. No. Des. 427,108 to Kevin B. Fisher, et al.

In the past, flag holders for bicycles have typically been secured between one of the rear axle drop-outs and an axle nut or between one of the drop-outs and a securing end of a quick-release skewer. As motorcycles are fundamentally powered bicycles, it was only logical that motorcycle flag holders should be secured between one of the axle dropouts on the swing arm and the rear axle retaining nut. There are, however, several problems associated with such an arrangement. Firstly, the axle retaining nut is typically of the castle variety so that a cotter pin can connect a pair of slots in the castle nut by passing through an aperture in the end of the axle. When a bracket is placed between the dropout and the castle nut, the aperture in the axle may no longer align with a pair of slots in the castle nut. Secondly, if the bracket between the dropout and the axle retaining nut is made of soft metal such as aluminum, it may compromise the structural integrity of the friction-secured axle—especially in the case of high-horsepower vehicles. Thirdly, mounting a bracket beneath the axle securing nut requires partial disassembly of the vehicle. If the flag holder is to be used only periodically, the sequence of mounting and remounting could become a real nuisance.

What is needed is a flag holder which mounts on the nut which secures a motorcycle's rear axle (and the rear wheel) to the swing arm assembly. Ideally, the flag holder will be mountable and demountable with a commonly available lightweight and easily-carried tool.

### SUMMARY OF THE INVENTION

The present invention includes a flag holder for motorcycles, that clamps on the nut which secures the rear axle and wheel to the motorcycle's swing arm. Castle nuts are typically used in such applications so that the castle nut can be cotter pinned or safety wired to the axle. Such an arrangement prevents vibration from loosening the nut, which could conceivably have disastrous consequences. For a preferred embodiment of the invention, the flag holder clamps to the hexagonal portion of the axle nut to which a wrench may be applied to tighten or loosen the nut on the axle. Axle nuts come in a variety of sizes. As a general rule, the heaver and more powerful the motorcycle, the larger the nut. Asian motorcycles typically use 19, 24, 27, and 32 mm nuts. Motorcycles manufactured in the U.S. may use S.A.E. axle nuts measured in inches, and older English motorcycles may use nuts which are sized to Whitworth (W) or British Association (BA) standards. In any case, the invention can be adapted to any size axle nut.

The flag holder includes a main body formed from plate stock having spaced-apart first and second major planar surfaces. For a preferred embodiment, the main body has a regular-duodecagonally-shaped nut-securing aperture with a central an axis perpendicular to the major planar surfaces. The nut-securing aperture is sized to slide over the hexagonal portion of a particular axle nut. The main body incorporates a slit having walls perpendicular to the major planar surfaces that begins at an outer edge of the main body and terminates at an edge of the nut-securing aperture. First and second opposing portions of the main body on either side of the slit can be drawn together with a nut-securing bolt. As the opposing portions are drawn together, the nut-securing aperture shrinks in size and tightens around the axle nut. For a preferred embodiment of the invention, a first opposing portion of the main body adjacent the slit can be bored and tapped to threadably receive a bolt passing through a bore in the second opposing portion. Alternatively, each opposing portion can be equipped with an unthreaded bore that is aligned with the untreaded bore of the other opposing portion. A bolt or screw can be inserted through both unthreaded bores, and the end thereof fitted with a nut. As the nut engages the bolt or screw, the opposing portions are pulled together and the nut-securing aperture shrinks.

An alternative embodiment of the invention utilizes a hexagonally-shaped nut-retaining aperture. Although the rotational adjustability of the flag holder is reduced, it is still very useable. In order to achieve a desired rotational orientation of the flag holder, the axle may be rotated slightly to achieve a desired rotational position.

### BRIEF DESCRIPTION OF THE DRAWINGS

FIG. 1 is a front elevational view of a prior art castle nut of the type used to secure an axle and wheel to a motorcycle swing arm;

FIG. 2 is a side elevational view of the castle nut of FIG. 1;

FIG. 3 is an exploded side elevational view of the preferred embodiment of the new flag holder;

FIG. 4 is a side elevational view of a preferred embodiment of the new, fully assembled flag holder having a flag staff secured therein and showing a castle nut secured within the nut securing aperture;

FIG. 5 is an enlarged side elevational view of the new flag holder and castle nut of FIG. 4, with the castle nut having been rotated 30 degrees;

FIG. 6 is a bottom plan view of the new flag holder of FIG. 6;

FIG. 7 is a rear elevational view of the new flag holder of FIG. 6;

FIG. 8 is a top plan view of the new flag holder of FIG. 6;

FIG. 9 is a front elevational view of the new flag holder of FIG. 6; and

FIG. 10 is a side elevational view of a motorcycle of the motocross type equipped with a flag holder which conforms to the present invention.

### DETAILED DESCRIPTION OF THE INVENTION

The invention will now be described with reference to the included drawing figures. It is to be understood that the drawings are not necessarily drawn to scale, and that they are intended to be merely illustrative.

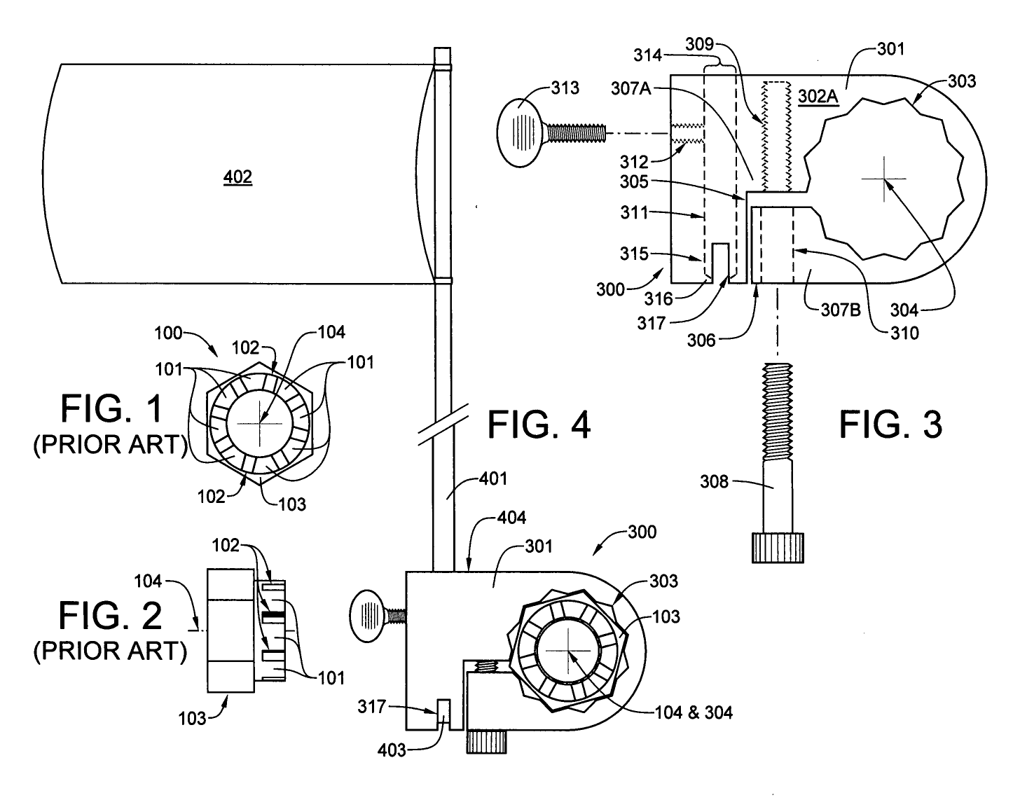

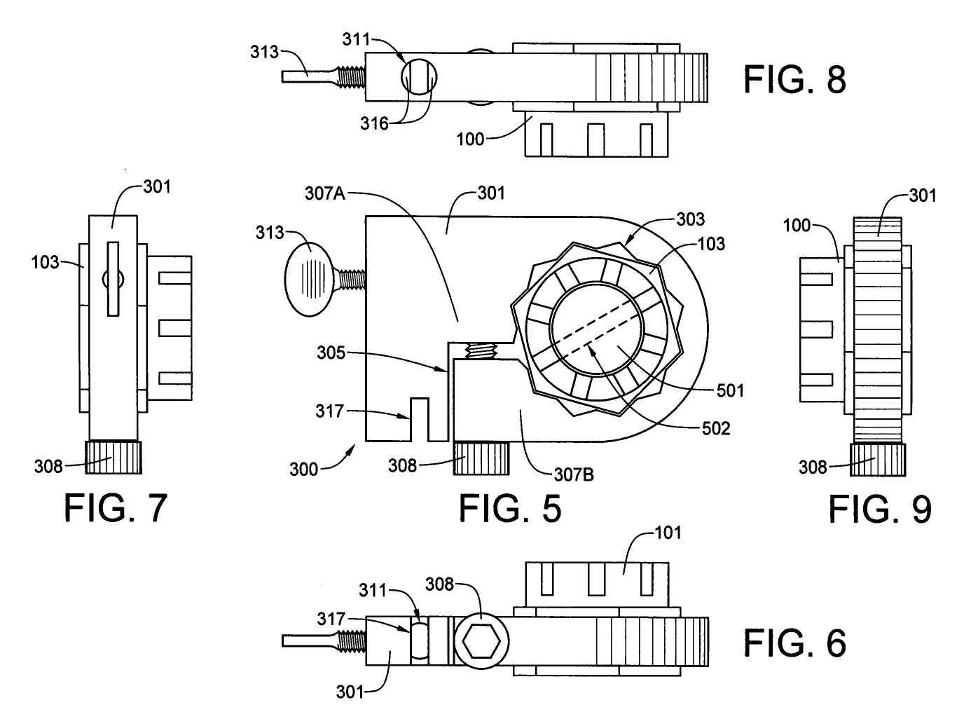

Referring now to FIGS. 1 and 2, a prior art hexagonal castle nut 100 has eight castellations 101. Each adjacent pair of castellations is separated by a slot 102. There are four pairs of mutually-aligned slots. Each pair may be aligned with a diametric aperture within the end of an axle. A cotter pin passing through the diametric aperture and connecting two mutually-aligned slots prevents vibration from loosening the nut. The hexagonal portion 103 of the castle nut 100 may be engaged with a spanner wrench, box-end wrench, or socket wrench.

Referring now to FIG. 3, a flag holder 300 conforming to the preferred embodiment of the present invention is secured to a rear axle castle nut (also referred to as a castellated rear axle nut) 100. The flag holder 300 includes a main body 301 that is preferably cut or machined from laminar plate stock having spaced-apart parallel first and second major planar surfaces 302A and 302B (surface 302B, though not visible in this view, is a mirror image of surface 302A). As an alternative to forming the main body 301 from plate stock, the main body may be cast. Aluminum or an aluminum alloy is considered the preferred material from which to fabricate the main body 301. The main body 301 is depicted with various cylindrical bores shown with dashed, or hidden, lines. For a preferred embodiment of the invention, the main body 301 has a regular-duodecagonally-shaped nut-securing aperture 303 with a central axis 304 that is perpendicular to the major planar surfaces 302A and 302B. For a main body 301 cut from plate stock, the nut securing aperture 303 is formed preferably by running a broach through a cylindrical aperture. For a cast aluminum main body, the regular duodecagonal shape of the nut securing aperture 303 may provided by the mold. Alternatively, the main body 301 may be cut with a high-pressure water jet. The disadvantage to high-pressure water cutting is that the cut is not perfectly square.

Still referring to FIG. 3, the nut-securing aperture 303 is sized to slide over the hexagonal portion 103 of a particular-size castellated rear axle nut 100. The main body 301 incorporates a slit 305 having walls perpendicular to the major planar surfaces 302A and 302B. The slit 305 begins at an outer edge 306 of the main body 301 and intersects the nut-securing aperture 303. First and second opposed, spaced-apart portions 307A and 307B of the main body 301, which are located on either side of the slit 305) can be drawn together with a nut-securing bolt 308. As the nut-securing aperture 303 is regular-duodecagonally shaped, the main body may be installed on the castellated rear axle nut 100 in 30-degree rotational increments. As the first and second opposed, spaced-apart portions 307A and 307B are drawn together by the nut-securing bolt 308, the nut-securing aperture 303 shrinks in size and tightens around the castellated rear axle nut 100. For a preferred embodiment of the invention, the first opposed portion 307A of the main body 301 can be equipped with a first threaded cylindrical bore 309 (shown with dashed, or hidden, lines), which is sized to threadably receive the nut securing bolt 308, the shank of which passes through a smooth cylindrical bore 310 (also shown with dashed, or hidden, lines) in the second opposed portion 307B. The main body 301 is equipped with a flag staff retaining cylindrical bore 311 (also shown with dashed, or hidden, lines) in the main body 301. A second threaded cylindrical bore 312 (also shown with dashed, or hidden, lines) orthogonal to the flag staff retaining bore 311 threadably receives a thumb screw 313, which can be tightened against an inserted flag staff in order to secure it within the flag staff retaining bore 311. There is a broken staff removal slot 314 which bisects the flag staff retaining cylindrical bore 311.

Referring now to exploded view of FIG. 4, a fully-assembled flag holder 300 is shown. A flag staff 401 is secured within the flag staff retaining bore 311 and a flag 402 is attached to the flag staff 401. The lower end 403 of the flag staff 401 is visible through the broken staff removal slot 314. If the flag staff 401 breaks off flush with the upper edge 404 of the main body 301, the broken end thereof can be removed by using a key, knife, or similar thin object, to push the broken end upwards until it can be grasped above the upper edge 404.

Referring now the different views of the new flag holder 300 and a castellated axle nut 100 retained therein, it can be better seen from various angles how the hexagonal portion 103 of the nut 100 fits within the nut securing aperture 303. Other features of the first threaded cylindrical bore 309, the smooth cylindrical bore 310, the flag staff retaining cylindrical bore 311, the second threaded cylindrical bore 312, and the broken staff removal slot 314 are clearly visible in these view.

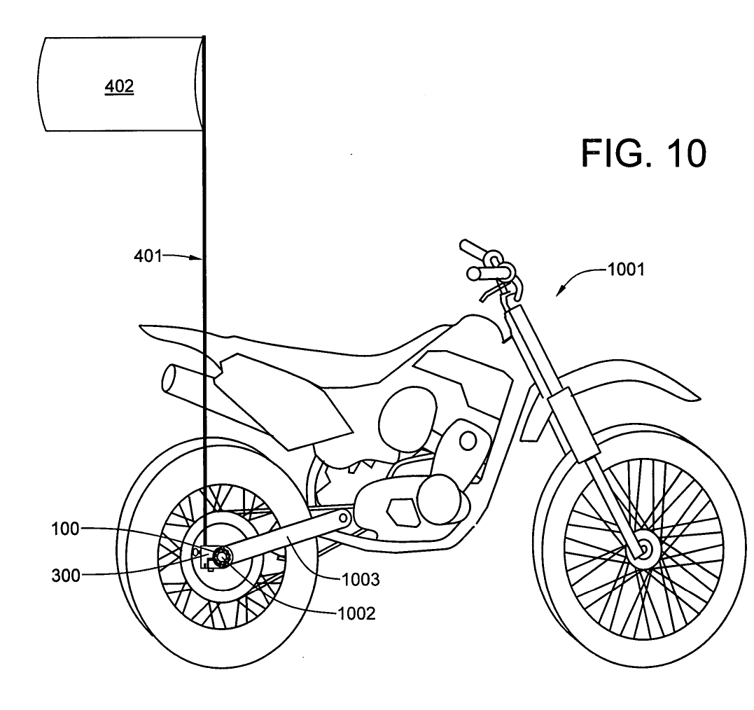

Referring now to FIG. 10, a motocross-type motorcycle 1001 is shown, which has a preferred embodiment of the flag holder 300 of the present invention secured to the rear axle nut 100. The rear axle nut 100 secured the axle 1002 to the rear suspension swing arm 1003.

Although only several embodiments of the invention has been shown and described, it will be obvious to those having ordinary skill in the art that changes and modifications may be made thereto without departing from the scope and the spirit of the invention as hereinafter claimed.

1. A flag holder securable to a hexagonal nut, the flag holder comprising:
a generally laminar, one-piece main body having back-to-back parallel major planar surfaces, a flag staff retaining bore parallel to said major planar surfaces; and a nut securing aperture sized to axially slide over the hexagonal nut, the nut securing aperture having a central axis perpendicular to said major planar surfaces; and
means for clamping the nut securing aperture around the hexagonal nut.

2. The flag holder of claim 1, wherein said nut securing aperture is regular-duodecagonally shaped.

3. The flag holder of claim 1, wherein said means for clamping comprises:
a slit which begins at an edge of said main body and intersects the nut securing aperture, said slit providing a pair of opposed, spaced-apart portions on said main body; and
means for drawing together said pair of opposed, spaced-apart portions in order to shrink the size of the nut securing aperture.

4. The flag holder of claim 3, wherein said means for drawing together comprises:
a bore in each of said opposing portions, said pair of bores being axially aligned and sized to receive a threaded fastener selected from the class consisting of bolts and machine screws, said threaded fastener being tightenable to draw together said opposing portions.

5. The flag holder of claim 1, wherein said main body is cut from aluminum plate stock.

6. The flag holder of claim 1, wherein said main body is cast.

7. The flag holder of claim 1, which further comprises:
a threaded bore perpendicular to the flag staff retaining bore; and
a thumb screw which threadably engages the threaded bore and is adapted to bear against a flag staff that is inserted within the flag staff retaining bore.

8. The flag holder of claim 4, wherein one of the axially aligned bores is threaded to engage the threads of the threaded fastener, when the threaded fastener is inserted first through the other axially aligned bore.

9. The flag holder of claim 1, wherein said flag staff retaining bore does not extend completely through said main body, said flag staff retaining bore being fully open at only at a first end thereof, a second end thereof having a blockage adapted to limit insertion of a flag staff, said second end incorporating a broken flag staff removal slot, which intersects said second end of the flag staff retaining bore.

10. A flag holder securable to a hexagonal nut which secures a rear wheel and rear axle to a rear suspension swing arm of a motorcycle, the flag holder comprising:
a one-piece main body having a flag staff retaining bore therein, a nut securing aperture sized to axially slide over the hexagonal nut, the nut securing aperture having a central axis perpendicular to said flag staff retaining bore; and
means for clamping the nut securing aperture around the hexagonal nut.

11. The flag holder of claim 10, wherein said means for clamping comprises:
a slit which begins at an edge of said main body and intersects the nut securing aperture, said slit providing a pair of opposed, spaced-apart portions which are interconnected by a portion of said main body which surrounds said nut securing aperture; and
means for drawing together said pair of opposed, spaced-apart portions in order to shrink the size of the nut securing aperture.

12. The flag holder of claim 11, wherein said means for drawing together comprises:
a threaded fastener that, when tightened, acts on both of said opposed, spaced-apart portions to draw them together.

13. The flag holder of claim 10, wherein said main body is cut from aluminum plate stock.

14. The flag holder of claim 10, wherein said main body is cast.

15. The motorcycle flag holder of claim 10, which further comprises:
a threaded bore perpendicular to the flag staff retaining bore; and
a thumb screw which threadably engages the threaded bore and is adapted to bear against a flag staff that is inserted within the flag staff retaining bore.

16. The flag holder of claim 10, wherein said flag staff retaining bore does not extend completely through said main body, said flag staff retaining bore being fully open at only at a first end thereof, a second end thereof having a blockage adapted to limit insertion of a flag staff, said second end incorporating a broken flag staff removal slot, which intersects said second end of the flag staff retaining bore.

17. A flag holder securable to a nut having a hexagonal portion for engaging a wrench, the flag holder comprising a generally laminar, one-piece main body having a flag staff retaining bore therein and a nut securing aperture sized to axially slide over the hexagonal portion of the nut, the nut securing aperture having a central axis perpendicular to said flag staff retaining bore, and the nut securing aperture being clampable about the nut.

18. The flag holder of claim 17, wherein said nut securing aperture is regular-duodecagonally shaped.

19. The motorcycle flag holder of claim 17, which further comprises:
a threaded bore perpendicular to the flag staff retaining bore; and
a thumb screw which threadably engages the threaded bore and is adapted to bear against a flag staff that is inserted within the flag staff retaining bore.

20. The flag holder of claim 17, wherein said flag staff retaining bore does not extend completely through said main body, said flag staff retaining bore being fully open at only at a first end thereof, a second end thereof having a blockage adapted to limit insertion of a flag staff, said second end incorporating a broken flag staff removal slot, which intersects said second end of the flag staff retaining bore.
